(19) United States
(12) Patent Application Publication
(10) Pub. No.: US 2010/0048123 A1
(43) Pub. Date: Feb. 25, 2010

(54) SYSTEM AND METHOD FOR ENERGY EFFICIENT AIR COOLING, EXCHANGE AND CIRCULATION

(76) Inventor: Lawrence O'Gorman, Madison, NJ (US)

Correspondence Address: Lawrence O'Gorman, 18 Albright Circle, Madison, NJ, 07940, US

(21) Appl. No.: 12/239,980

(22) Filed: Sep. 29, 2008

Related U.S. Application Data
(60) Provisional application No. 61/091,567, filed on Aug. 25, 2008.

(51) Int. Cl. E06B 7/02; F24F 7/007; F24F 3/14

(52) U.S. Cl. 454/212; 454/252; 236/44 C

(57) ABSTRACT

An airflow management device is described that assists air cooling, exchange, and circulation of interior spaces by creating inward and outward airflow through a window opening. The device measures temperatures outside and inside a room, and determines when to exhaust warmer ceiling air and to draw cooler outside air. The exhaust component of the device captures warmer air at a higher level of the room and exhausts it through a window opening at a lower level. The intake component of the device draws cooler outside air through the window opening and discharges it into the room at a lower level than exhaust inflow. By expelling air from a high level and drawing it at a lower level, the room vertical temperature gradient is maintained thus optimizing cooling effectiveness. By microcontroller regulation of inflow and outflow, air pressure equilibrium between outside and inside is maintained thus maximizing airflow efficiency.

### CROSS-REFERENCE TO RELATED APPLICATIONS

This application claims the benefit of U.S. Provisional Application Ser. No. 61/091,567, filed on Aug. 25, 2008. The disclosure of the above application is incorporated herein by reference in its entirety for any purpose.

### FIELD OF THE INVENTION

The present invention generally relates to air cooling, exchange and circulation, and particularly relates to exchanging of inside room air with outside air for energy efficiency.

### BACKGROUND OF THE INVENTION

It is a common experience during warm weather to find that an inside room accumulates and retains heat above the temperature of the outside. This thermal inertia is especially noticeable at night when outside temperatures turn cooler, but room temperature remains uncomfortably warm. Merely opening one or more windows may not cool the room to the outside temperature because there is no natural airflow. If the room has more than one window, if the windows are on different walls, and if there is some airflow outside, a cross-draft can move outside air into the room and inside air out to reduce the inside temperature. However, it is not always possible due to window configuration or outside conditions to create a cross-draft. Even if a cross-draft can be created, heat will often persist at room heights above the highest window opening. This is effectively an inverted well of hot air that is difficult to drain.

More active solutions include a window fan, which is used either to draw in cooler outside air or expel warmer inside air. However, a window fan without a cross-draft quickly creates a pressure imbalance between inside and outside resisting further exhaust or drawing of air. If a cross-draft can be established, window fans can help exchange some inside air, but they are still largely ineffective in draining the hot air well above the top of the window fan. Another active solution is to use a ceiling fan, but this just circulates and mixes the warm and cooler air in the room without lowering the average temperature. In all these circumstances, despite cooler air outside, a warmer inside space cannot be quickly and effectively cooled.

Inside cooling can be accomplished easily by air conditioning. However, there are drawbacks to air conditioning. One is electricity cost. A 10,000 BTU/hour window air conditioner consumes 500-1000 watts, which is 10 to 20 times the energy consumption of a single window or ceiling fan. Energy consumption is directly related to global warming effects, which is becoming more of a concern to many people. There are other drawbacks to air conditioners that vary with people's preferences: compressor noise is too loud, cooled air is too cold, the quality of fresh outside air is preferable to air conditioned air, a portable window unit is unsightly, and permanent installation is inconvenient or disallowed in some rental premises.

It is therefore the objective of the present invention to provide an economical and environmentally friendly air cooling, exchange, and circulating appliance. Particularly, it is the objective of the present invention to provide air circulation (1) when inside room temperature is warmer than desired, and (2) when outside temperature is lower than inside. It is further the objective of the present invention to create a cross-draft inside a room that cools the inside thoroughly and quickly to a more desired temperature. Further, another objective of the present invention is to provide a device that is advantageous in comparison to an air conditioner with respect to cost of operation and its carbon footprint. Yet another objective of the present invention is to provide a system that is portable, that does not require permanent or major installation to the infrastructure, and has an aesthetically pleasing design.

### SUMMARY OF THE INVENTION

According to the present invention, the device is equipped with an upper exhaust chamber directed to exhaust the warm air out of the room; a lower intake chamber to direct outside air through an opening such as a window to the inside room; and a controller to control the operation of the upper and lower chambers and airflow.

According to one feature of the invention, the input opening of the upper exhaust chamber is positioned relatively high in the room and preferably above the level of the window opening to capture and expel the unwanted warm air that rises from middle and lower level in the room. The input opening of the lower intake chamber is positioned relatively at or below the window seal level to draw in cool fresh outside air to the room and force the warm air inside the room up to a high level in the room, to be exhausted by the upper exhaust chamber. This cross-draft created by this intake and exhaust will cool the room more thoroughly and quickly to the desired temperature.

According to another feature of the present invention, the device can be operated in cooling mode to reduce room temperature either as an augmentation to standard air conditioning or on its own. When temperature differentials are appropriate between inside and outside, the device brings cool air into the room and expels warmer air. Even if temperature inversion only happens at night, venting of accumulated internal heat at night and into the next day provides cooling into the next day and prevents heat build-up.

According to yet another feature of the invention, the device can be operated in the air exchange mode to vent inside air out, and replace it with fresh outside air. This function can be used just to freshen otherwise stale air, or to remove odors from rooms such as kitchens and restrooms. In this exchange mode, fresh outside air is prevented from mixing with stale inside air before the stale inside air is expelled, because the input of the exhaust chamber is located at a higher level of the room and the output of the intake chamber is located at a lower level. The exchange mode can be auto or manual. In the Exchange-Auto mode, the air temperature controller assures that this exchange function will not also produce unwanted high or low temperature changes. In the Exchange-Manual mode, the system operates independently of room or outside temperatures.

According to yet another feature of the invention, the device can be operated in air circulation mode to perform internal air circulation, similar in function to a ceiling fan. An advantage of this device over a ceiling fan is that it is portable and requires no installation. The circulation mode can be auto or manual. In Circulation-Auto mode, the systems operates and shuts off based on the room temperatures. In the Circulation-Manual mode, the system operates independently of room temperatures. For the air circulation mode, the device provides a function even when summer heat has passed and most window fans and air conditioners have been turned off and stored until the next hot season.

According to yet another feature of the invention, the device controller uses three sensors: one outside temperature sensor and two inside temperature sensors to control the switching of cooling, exchange and circulation modes. One room sensor is preferably located at a high level of the room near the input of the exhaust chamber. The other room sensor is preferably located at a lower level of the room at a similar level of the output of the intake chamber, however the lower level sensor should not be located at the output of the intake chamber because it should measure room temperature air rather than drawn outside air.

The present invention is advantageous over previous air circulation methods and systems in that the present invention provides a cross-draft of air from low to high inside a room that can efficiently expel unwanted warm air in the room and therefore lower the temperature quickly.

Further, the advantage of the present invention includes the use of two room temperature sensors in order to take advantage of the cool-to-warm air temperature gradient from low-to-high levels of a room, and thus to provide air circulation and cooling more efficiently based on the need of each individual room.

For a more thorough understanding of the invention, its objectives and advantages, refer to the following specification and to the accompanying drawings.

### BRIEF DESCRIPTION OF THE DRAWINGS

The present invention will become more fully understood from the detailed description and the accompanying drawings, wherein:

FIG. 1 is a view of two physical configurations of the device according to the present invention;

FIG. 2 is the side view of device set up at window of a room according to the present invention;

FIG. 3 is the front and side view of device according to the present invention;

FIG. 4 is an illustration of controller and temperature sensors according to the present invention;

FIG. 5 is illustration of device designed with the external appearance of a Japanese shoji lamp according to the present invention;

FIG. 6 is an illustration of airflow for cooling, exchange, and circulation modes according to the present invention;

FIG. 7 is an illustration of cross-draft through a single window opening according to the present invention;

FIG. 8 is an illustration of build-in device according to the present invention;

FIG. 9 is an illustration of transparent and translucent chamber according to the present invention.

### DETAILED DESCRIPTION OF THE PREFERRED EMBODIMENTS

The following description of the preferred embodiment(s) is merely exemplary in nature and is in no way intended to limit the invention, application, or uses.

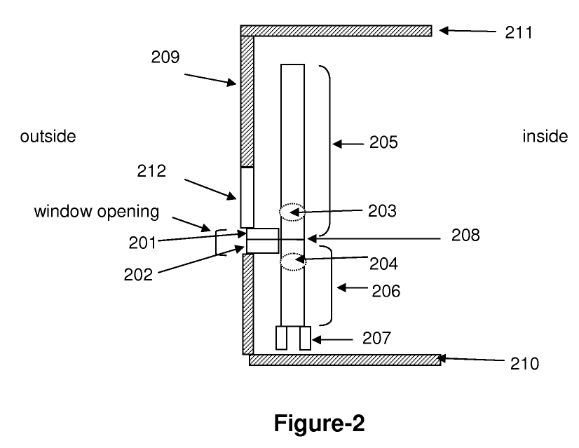

By way of overview, the present invention essentially discloses three main components: an upper and lower airflow chamber, and a controller, as illustrated in FIGS. 2, 3, and 4.

1. Upper Exhaust Chamber. The upper exhaust chamber (205, 301) includes a vertical airflow conduit that extends from a high level of the room near the ceiling down to the level of the window opening. This component has an opening or window conduit (201, 305) and a fan (203) or other subcomponent to draw air from an opening (304) in the top of the chamber and to direct the airflow downward through the chamber (205, 301) and through the conduit (201, 305) directed to exhaust the air out the window. This component also includes a partition door that opens or closes the exhaust airflow to outside opening conduit (201, 305).

2. Lower Intake Chamber. The lower intake chamber (206, 302) includes a vertical airflow conduit that extends from the window entry level to the same level or a lower level toward the floor. This component has an opening or window conduit (202, 306) and a fan (204) or other subcomponent to draw air from outside, through the conduit (202, 306) designed to direct air downward through the chamber (206, 302) and toward an exit opening at the bottom of the chamber (307) to the inside of the room. This component also includes a partition door that opens or closes the airflow to draw in from outside opening conduit (202, 306).

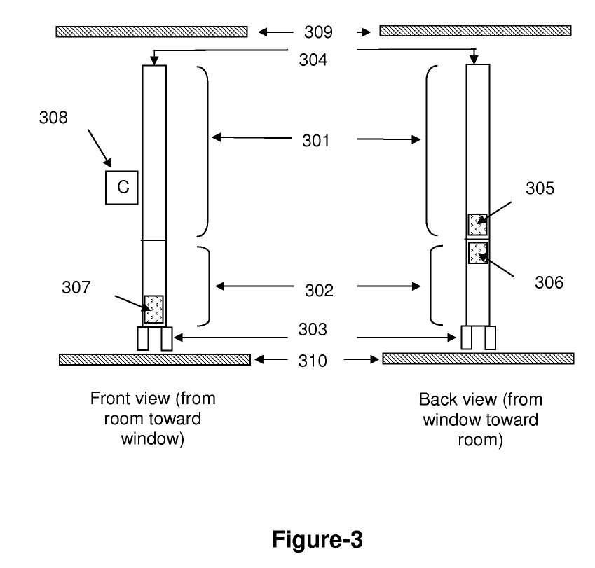

Further in reference to FIG. 3, the opening conduit 305 and 306 can be positioned at a window opening in combination with a window seal that impedes airflow through parts of the window opening that are not directly open for exit from the upper exhaust chamber and entry into the lower intake chamber.

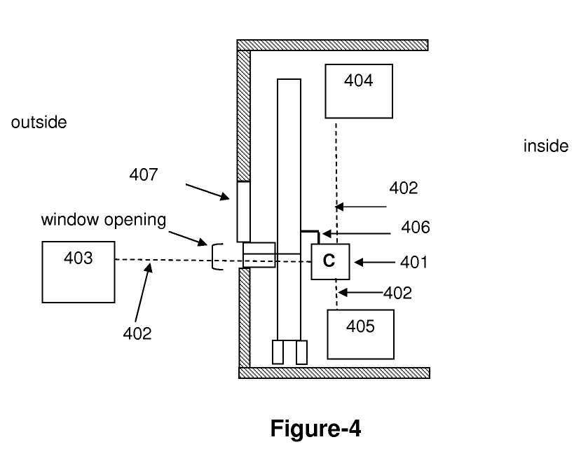

3. Controller. In reference to FIG. 4, the controller (401) is a microcontroller that executes software instructions built-in. The controller receives readings wired or wirelessly (402) from preferably three sensors: outside sensor (403), indoor sensor at high level of the room toward the ceiling (404), and indoor sensor at lower level of the room toward the floor (405), and uses the readings to control the operation of the upper and lower chambers and airflow including the fans and chamber partition doors.

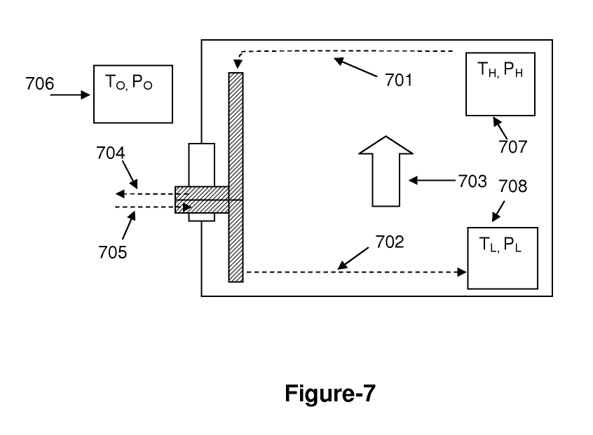

In reference to FIG. 7, the basic operation of the device takes advantage of the physical property that warm air rises and accumulates toward the ceiling in a room, as shown in the direction of arrow (703). This temperature gradient between warm air toward the ceiling at temperature T_{H} (707), and cooler air at a lower level at temperature T_{L} (708) dictates that the upper exhaust chamber captures warm air (701) at its uppermost level and the lower intake chamber expels cooler air (705) drawn from the outside at temperature T_{O} (706) into the room at its lowermost level. Efficient operation depends on the cool air filling from floor to ceiling (rather than temperature levels being mixed as is done by ceiling fans and most window fans) because only the warmest air should be expelled at all times.

A fundamental operating feature of the device is that it effectively creates its own cross-draft through a single window. The cross-draft is essentially vertical, in the direction of arrow (703), between exit at the lower chamber and entry at the upper chamber. This vertical cross-draft from low to high assures that it is always the warmer air that is being expelled and that incoming cooler air does not mix with the warmer air, and thus be expelled inadvertently. Furthermore, this vertical cross-draft maintains the average room air pressure in equilibrium with the outside air pressure, that is P_{O}=½(P_{H}+P_{L}), where P_{H} is the pressure toward the ceiling and P_{L} is the pressure toward the floor.

The device has five possible states of operation: 1) off, 2) intake only, 3) exhaust only, 4) intake and exhaust, and 5) circulate. The states are determined in part by the chosen mode: 1) cool, 2) exchange (automatic or manual), 3) circulate (automatic or manual), and 4) off. Except for the manual and off modes, the state is determined automatically by the controller based on pre-determined conditions, which depend upon absolute and differential inside and outside temperatures as measured by the temperature sensors, and by user-chosen temperature settings. The measured outside temperature is designated T_{O}. There are two inside temperatures, T_{H} measured at a high level toward the ceiling, and T_{L} measured at a lower level, preferably at a level between the lower window opening and the floor. The two user-chosen temperature settings are the goal temperature T_{G} and the minimum temperature T_{MIN}, upon which the condition exists that T_{G}>T_{MIN}. The device has default values for these two settings. An example of these default values is, T_{G}=22° C. (72° F.) and T_{MIN}=18° C. (65° F.). Modes, temperature conditions, and corresponding states are shown in Table 1.

TABLE 1
Modes, temperature pre-determined conditions, and
corresponding states.

| Mode | Temperatures | State |
|---|---|---|
| Cool | (T_{H} > T_{G} AND T_{H} > T_{O}) AND | intake and exhaust |
| | (T_{L} > T_{Min} OR T_{O} > T_{Min}) | |
| Cool | T_{H} > T_{G} AND T_{O} > T_{L} | exhaust only |
| Exchange Auto | T_{L} > T_{Min} | intake and exhaust |
| Exchange Manual | Any | intake and exhaust |
| Circulate Auto | T_{H} > T_{Min} | circulate |
| Circulate Manual | Any | circulate |
| Off | Any | off |

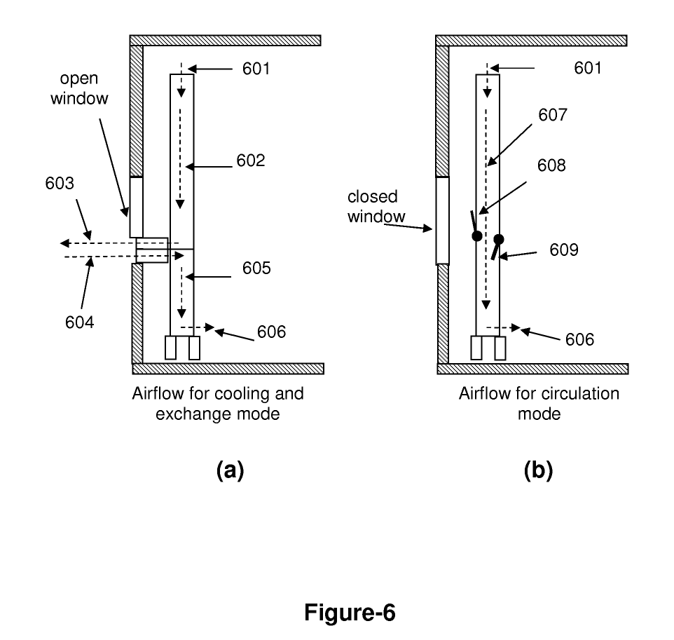

From Table 1, and further in reference to FIG. 6(a), there are two states in the cool mode. In the first state, both intake and exhaust fans are on, and both these chamber doors are opened to allow airflow from outside (604) through lower intake chamber (605) and opening (606) to the room, and capture warm air in the room at upper exhaust chamber air entry (601), through the chamber (602) to exhaust to outside (603). This state is chosen if the inside high level temperature is above the goal temperature and above the outside temperature, and if the inside low level temperature is above the minimum temperature or the outside temperature is above the minimum temperature. This is the optimum cooling setting and is selected when the inside is hot and the outside is cooler than the inside.

In the second cool mode state, only the exhaust fan for the upper exhaust chamber is on. The exhaust chamber door is opened to allow outflow to outside (603) and the intake chamber door is closed to prevent inflow (604). This state is chosen if the high temperature is above the goal temperature and the outside temperature is above the low level temperature. This setting is selected when it is warm inside, but the outside temperature is too hot to be useful in cooling the room—so only hot ceiling air is vented.

From Table 1, and further in reference to FIG. 6(a), there are two exchange options, automatic and manual. The intake and exhaust fans run for both exchange options, so both exhaust (603) and intake (604) chamber doors are opened, and both intake airflow (605) and exhaust airflow (602) occur. For the automatic option, exchange takes place only when the low level temperature is above the minimum temperature, since we don't want to add airflow cooling to an already cold room. For the manual option, exchange takes place independent of temperature.

From Table 1, and further in reference to FIG. 6(b), there are two circulate options, automatic and manual. The circulate mode moves air from a high level through the upper exhaust chamber input opening (601), through both the upper and lower exhaust chambers (607), and out into the room through lower intake chamber output opening (606). Both exhaust and intake fans run. The exhaust door (608) and intake doors (609) are both closed to outside air and airflows from upper exhaust chamber to lower intake chamber. Since no window exhaust or intake takes place, the window need not be open and it is not used. For the automatic option, circulation runs when the high level temperature is above the minimum temperature. This causes mixing of air levels and reduction of the floor-to-ceiling temperature gradient when heat has built up toward the ceiling. For the manual option, circulation runs independent of temperature.

For the off state, both fans are turned off and both chamber doors are closed.

### VARIATIONS ON THE PREFERRED EMBODIMENT

The above describes only one embodiment. Variations of this design can also be made to accomplish the same functions.

In another embodiment according to the present invention, instead of measuring just temperature, temperature and humidity can be measured by the temperature sensors to yield a temperature-humidity index (THI. The THI is a humidity-adjusted temperature value designed to measure human discomfort to the combined effects of temperature and humidity. A calculation of this is: THI=15+0.4(T_{d}+T_{w}), or THI=T_{d}−0.55(1−H)(T_{d}−58), where T_{d} and T_{w} are the dry- and wet-bulb temperatures respectively measured in Fahrenheit degrees, and H is the relative humidity in percent. Use of THI versus temperature alone requires that the temperature sensors measure both temperature and humidity.

In another embodiment according to the present invention, instead of two fans, this can be reduced to one by placing it in a shared intake/exhaust conduit through the window, then enabling the single fan to reverse airflow direction as dictated by the controller, expelling air out for exhaust and drawing air in for intake. For exhaust, a door opens the exhaust chamber and closes the intake chamber. For intake, a door opens the intake chamber and closes the exhaust chamber.

Yet in another embodiment according to the present invention, instead of an integrated intake fan, this can be omitted and replaced by a fan unit that is separate from the device. The separate device is placed or attached to the exit opening of the lower intake chamber in a way that it draws air through the intake chamber. An air cleaner unit with integrated fan is advantageous here because the drawn outside air would then flow through and be cleaned by the air cleaner.

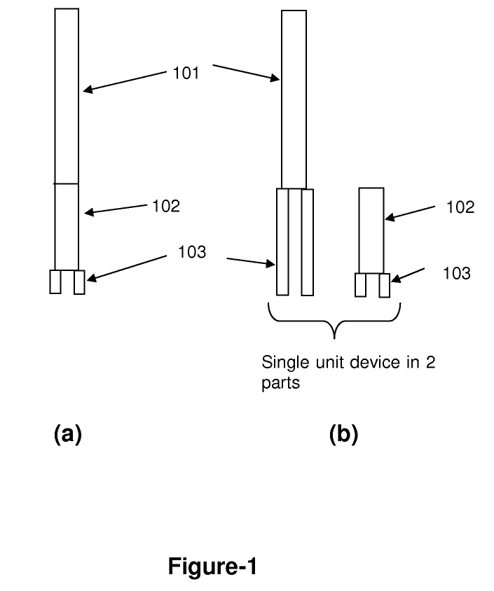

In another embodiment according to the present invention, as shown in FIG. 1, instead of a single unit, the upper exhaust chamber (101) and lower intake chamber (102) can be separate units, each with its own stand (103). This has an advantage of being able to move the exhaust exit away from the intake entry, such that warm exhaust air does not mix with intake air near the window opening.

Further in another embodiment according to the present invention, instead of running exhaust and intake concurrently for cool mode, they can be run sequentially to reduce mixing exhaust air with intake air. Because pressure equilibrium between inside and outside will not be maintained if either intake or exhaust runs too long, they can run alternately at a timing interval designed to prevent pressure imbalance. Alternatively, pressure imbalance can be determined by measuring fan resistance, and the switch made between intake and exhaust and vice versa when that value is above a chosen threshold.

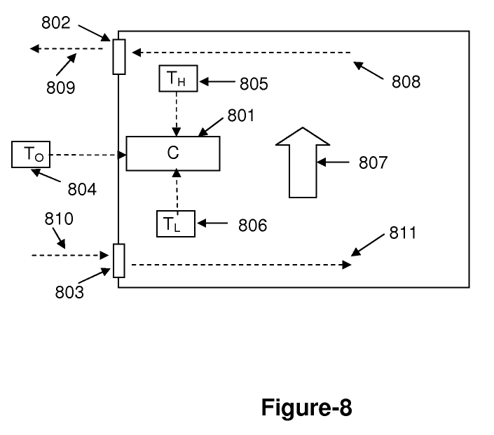

Yet in another embodiment according to the present invention, as shown in FIG. 8, instead of directing airflow through the opening of a window, vents can be placed or built into the wall at a high level (802) and a lower level (803). Using the same control logic (801), exhaust and intake can be performed through these vents.

In another embodiment according to the present invention, instead of a double-hung window type, where there is a horizontal opening between lower sash and window sill, the device can also work with a casement window (which opens out from hinges at a side). For a casement window, the upper exhaust chamber need only direct airflow from a high level to the top of the casement window opening. The lower intake chamber directs air from the bottom of the casement window opening.

In another embodiment according to the present invention, the device can be made into an entirely manual system without requiring any temperature sensors. The function of the controller will be only controlling the turning on and off of fans and the partition doors. In the complete manual mode, the device can still be configured to run in the following states: Exhaust only, Intake and Exhaust (Exchange—with outside air) or Intake and Exhaust (Circulate—without outside air).

### Form and Function

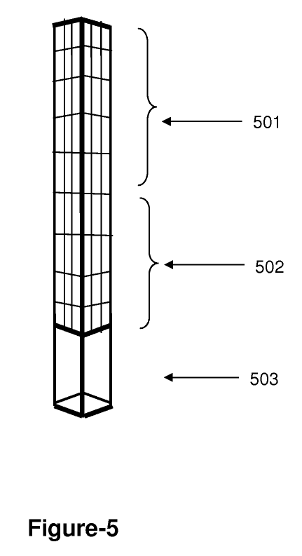

The walls of the cylinder can be opaque, transparent, or translucent. The “degree of transparency” describes the degree of visibility of an object through a material, where visibility is dependent upon the amount of light that can travel through the material (transmittance), ranging from opaque to transparent, and the clarity by which the object can be seen through the material (translucence). The present invention has an exemplary form similar to a Japanese shoji lamp. It is a tall, thin, square cylinder, as shown in FIG. 5. This cylinder comprises the upper exhaust (501), lower intake chambers (502) and stand (503). The chambers have translucent walls made of rice paper. Walls with some non-zero degree of transparency are advantageous to allow light to pass from window through the device if the device is placed in front of a window.

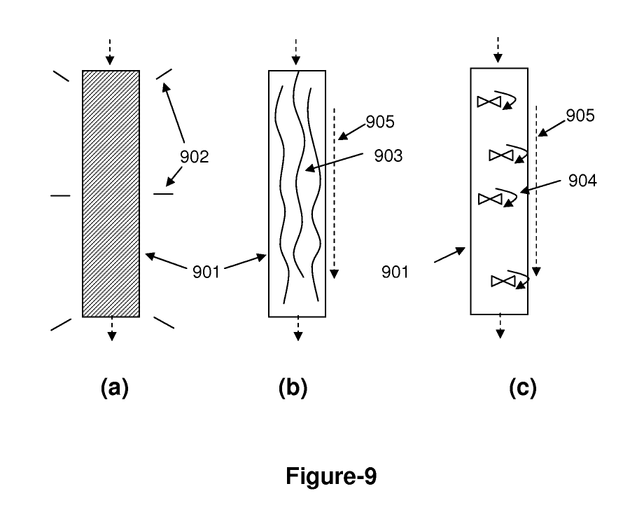

In another embodiment according to the present invention, instead of an indicator light (usually a small LED light) that many fans use to indicate an ON mode, the device with transparent or translucent chamber walls could indicate ON mode by motion of one or more objects due to airflow. Translucent or transparent walls can also be combined with ribbons, streamers, or some other dynamic object or sculpture placed in a chamber to give a pleasing visual display and to indicate when the device is operating. Transparent or translucent walls also enable dual function of the device as both a fan and lamp. For example, as shown in FIG. 9(a), the chamber (901) glows from internal light (902) when turned on. As shown in FIG. 9(b), the streamer (903) inside the chamber moves as the device is turned on and there is vertical airflow (905). Further, as shown in FIG. 9(c), the objects such as maple seeds (904) hanging inside the chamber rotates as the device is turned on and there is vertical airflow (905).

The description of the invention is merely exemplary in nature and, thus, variations that do not depart from the gist of the invention are intended to be within the scope of the invention. For example, the position, size and number of openings for both upper exhaust chamber and lower inlet chamber can vary. Still further, a special opening in the structure of outside wall can be used to exhaust room air and draw in outside air in lieu of a window opening. Still further variations, including combinations and/or alternative implementations, of the embodiments described herein can be readily obtained by one skilled in the art without burdensome and/or undue experimentation. Such variations are not to be regarded as a departure from the spirit and scope of the invention.

What is claimed is:

1. An air ventilation system for use in cooling, exchanging, and circulating air inside a room comprising:
a first conduit that captures air from upper level of the room;
a second conduit that directs air to inside the room;
a first opening conduit that expels air from said first conduit to outside the room;
a second opening conduit that draws air from outside to be directed to said second conduit;
a fan unit;
a partition door that directs airflow in said first and second conduits;
a control unit operable to configure said fan unit and partition door to perform air cooling, exchange and circulation operation; and
a stand;
whereby said air cooling, exchange and circulation operation causes said system to operate in one of the modes comprising of:
(a) room air is captured from said first conduit and expelled to outside; and outside air is drawn from outside to inside the room through said second conduit;
(b) room air is captured by said first conduit and expelled to outside only; and no outside air is drawn to inside the room; and
(c) room air is captured from said first conduit and directed downward to said second conduit and expelled to inside the room; whereas no inside air is expelled to outside and no outside air is drawn to inside the room.

2. The system of claim 1, wherein said first opening conduit and second opening conduit are adapted to a window opening.

3. The system of claim 1, wherein all or portion of the walls of said first and second conduits have a non-zero degree of transparency.

4. The system of claim 3, wherein said conduit with non-zero degree of transparency includes inside an illuminating light that indicates the system is on.

5. The system of claim 3, wherein said conduit with non-zero degree of transparency includes inside at least one object that moves due to airflow to indicate that the system is on.

6. An air ventilation system for use in cooling, exchanging, and circulating air inside a room comprising:
a first conduit that captures air from upper level of the room;
a second conduit that directs air to inside the room;
a first opening conduit that expels air from said first conduit to outside the room;
a second opening conduit that draws air from outside to be directed to said second conduit;
a fan unit;
a partition door that directs airflow in said first and second conduits;
a control unit that automatically configures said fan unit and partition door to perform air cooling, exchange, and circulation operation based on a user set room temperature; ambient measures at upper level of the room; ambient measures at lower level of the room; and ambient measures at outside of the room; and
a stand;

7. The system of claim 6, wherein said air cooling, exchange, and circulation operation controlled by said control unit causes room air to be captured from said first conduit and expelled to outside; and air to be drawn from outside to inside the room through said second conduit.

8. The system of claim 6, wherein said air cooling, exchange, and circulation operation controlled by said control unit causes room air to be captured from said first conduit and expelled to outside only; and no outside air is drawn to inside the room.

9. The system of claim 6, wherein said air exchange and circulation operation controlled by said control unit causes air to be captured from said first conduit and directed downward to said second conduit and expelled to inside the room; whereas no inside air is expelled to outside and no outside air is drawn to inside the room.

10. The system of claim 6, wherein said ambient measurement is at least one of measures consisting of: temperature; humidity; and pressure.

11. The system of claim 6, wherein said first opening conduit and second opening conduit are adapted to an opening in the wall between inside room and outside that accomplishes both intake and exhaust of air.

12. A method of cooling, exchanging, and circulating air inside a room having an opening on the wall, floor or ceiling to outside the room, said method comprising the steps of:
setting user desired room temperature;
sensing the temperature at upper level inside of said room;
sensing the temperature at lower level inside of said room;
sensing the temperature at outside of said room; and
controlling and directing the airflow of said room based on said user set desired room temperature; said temperature at upper level; said temperature at lower level inside said room; and said temperature outside said room.

13. The method of claim 12, wherein said controlling and directing method causes the room air to be captured from upper level of said room and expelled to outside of said room through said opening on the wall and outside air to be drawn from outside of said room through said opening on the wall and directed to inside at lower level of said room when at least one pre-determined condition is met.

14. The method of claim 13, wherein said at least one pre-determined condition is met when: (a) said lower level temperature is greater than a predefined minimum room temperature or said outside temperature is greater than a predefined minimum room temperature; and (b) said upper level temperature is greater than said user desired temperature; and (c) said upper level temperature is greater than said outside temperature.

15. The method of claim 12, wherein said controlling and directing method causes room air to be captured from upper level of said room and expelled to outside only through said opening on the wall and no outside air is drawn to inside of said room when at least one pre-determined condition is met.

16. The method of claim 15, wherein said at least one pre-determined condition is met when: said outside temperature is greater than said lower level temperature; and said upper level temperature is greater than said user desired temperature.

17. The method of claim 12, wherein said controlling and directing method causes room air to be captured from upper level of said room and directed downward and circulated to lower level of said room; whereas no inside air of said room is expelled to outside and no outside air is drawn to inside of said room when at least one pre-determined condition is met.

18. The method of claim 17, wherein said at least one pre-determined condition is met when said upper level temperature is greater than a pre-defined minimum room temperature.

19. The method of claim 12, wherein said method of controlling and directing is further based on:
humidity of at least one location of said room; and
humidity of outside of said room.

20. The method of claim 12, wherein said method of controlling and directing is further based on:
air pressure of at least one location of said room; and
air pressure of outside of said room.
